(19) United States
(12) Patent Application Publication
(10) Pub. No.: US 2018/0058661 A1
(43) Pub. Date: Mar. 1, 2018

(54) MULTI-FACET LENS HAVING CONTINUOUS NON-SPHERICAL CURVED PORTION

(71) Applicant: HYUNDAI MOBIS CO., LTD., Yongin-si (KR)

(72) Inventor: Hyung Rok SHIM, Seoul (KR)

(73) Assignee: HYUNDAI MOBIS CO., LTD., Yongin-si (KR)

(21) Appl. No.: 15/586,886

(22) Filed: May 4, 2017

(30) Foreign Application Priority Data
Aug. 29, 2016 (KR) 10-2016-0110036

(51) Int. Cl. F21V 5/04; F21V 7/00

(52) U.S. Cl. CPC F21V 5/04; F21V 7/0091

(57) ABSTRACT

The present invention relates to a multi-facet lens having a continuous non-spherical curved portion, and more particularly, when a thickness direction of the lens is defined as a vertical direction, to a multi-facet lens having a continuous non-spherical curved portion which allows luminous efficiency to be improved through a continuous non-spherical curved portion which has no dummy surface and no step in a direction perpendicular to a light input portion of a vertical lens.

### CROSS-REFERENCE TO RELATED APPLICATION

This application claims priority to and the benefit of Korean Patent Application No. 10-2016-0110036, filed on Aug. 29, 2016, the disclosure of which is incorporated herein by reference in its entirety.

### BACKGROUND

### 1. Field of the Invention

The present invention relates to a multi-facet lens having a continuous non-spherical curved portion, and more particularly, when a thickness direction of the lens is defined as a vertical direction, to a multi-facet lens having a continuous non-spherical curved portion which allows luminous efficiency to be improved through a continuous non-spherical curved portion which has no dummy surface and no step in a direction perpendicular to a light input portion of a vertical lens (hereinafter, referred to as a vertical step).

### 2. Discussion of Related Art

Generally, when a light source, such as a liquid crystal display (LCD) or a light emitting diode (LED), is used as a lighting device or driving beam headlamp, the light source is used with a lens.

Particularly, an LED has a property having a very large radiation angle of lighting light. The LED is used for a function of emitting light for a wide area or being lit for a short distance.

Because the radiation angle according to the property of an LED is very large, when the LED performs a function of emitting light for a local area in a long distance, luminous efficiency of the LED can be seriously decreased because of an etendue problem.

An LED is used with a multi-facet lens (MFL) by considering the property of the luminous efficiency. The MFL is a condensing lens which collects light emitted from the LED or guides the light in a direction parallel to an optical axis.

The MFL according to a conventional technology is an optical device having a light input portion as disclosed in the following patent document. Here, a plurality of light input parts different from each other are individually manufactured and combined so that the light input portion of the MFL is formed as one body.

For example, the MFL according to the conventional technology is illustrated in FIGS. 1 to 3.

Referring to FIGS. 1 to 3, a body 1 of the MFL according to the conventional technology is manufactured by combining a plurality of light input parts. Here, although the light input parts have specifications different from each other, because the light input parts are individually cut from a structure of an total internal reflection (TIR) lens, the light input parts have shapes capable of figurally combining each other.

Accordingly, the light input portion in which the light input parts are combined inevitably has vertical steps 2 and 3. Here, a thickness direction of a lens may be defined as a direction of an optical axis or a vertical direction. The vertical steps 2 and 3 have height step surfaces according to the light input parts formed in a direction perpendicular to the light input parts (for instance, a height direction).

Scattered reflection of light of the light input portion occurs at the height step surfaces according to the light input parts that are the vertical steps 2 and 3.

In addition, because a position at which a plurality of vertical steps 2 and 3 meet is the center of the light input portion, a dummy surface 4 has to be formed at the center of the light input portion.

Accordingly, the MFL has a non-spherical area including curved surfaces different from each other on the basis of the property of the MFL according to the conventional technology.

In the light input portion included in a dotted line area II illustrated in FIG. 3, non-spherical areas 5, 6, and 7 corresponding to the vertical steps 2 and 3 have focal lengths different from each other.

For example, the MFL of the conventional technology has a problem in that the scattered reflection occurs at a surface of the vertical steps 2 and 3 or height step surfaces due to a focal length difference between a non-spherical area 5 having a short focal length and another non-spherical area 6 having a long focal length, or a focal length difference between the non-spherical area 5 having the short focal length and another non-spherical area 7.

In addition, in the MFL of the conventional technology, because a TIR is difficult to occur at the dummy surface 4 located at the center of the light input portion, there is a problem in that luminous efficiency is decreased.

### PRIOR ART DOCUMENT

### Patent Document

US Laid-open Patent Publication No. US2014-0036510

### SUMMARY OF THE INVENTION

The present invention is directed to a multi-facet lens (MFL) having a light input portion with a continuous non-spherical curved portion without vertical steps so that luminous efficiency and convenience of a molding process are improved as an MFL optical system, an improved radiation intensity is obtained by preventing scattered reflection, and a cost reduction is achieved for mass production.

According to an aspect of the present invention, there is provided an MFL having a continuous non-spherical curved portion including: a reflector provided with a total internal reflection structure including a first Bezier curved surface, a second Bezier curved surface, and a third Bezier curved surface, which have different shapes, such that light emitted from a light source is collected while having a feature of straightness parallel to an optical axis; a light input portion integrally formed at one side of the reflector and including inner wall surfaces extending from edges of the first Bezier curved surfaces, the second Bezier curved surfaces, and the third Bezier curved surfaces in an inward direction of the reflector, and a continuous non-spherical curved portion corresponding to a bottom surface of a groove-shaped space surrounded by the inner wall surfaces; and a light output portion integrally formed at the other side of the reflector and configured to emit light incident through the light input portion and light totally internally reflected by the reflector to be parallel to the optical axis.

The continuous non-spherical curved portion may be formed in a curved surface extending from corner portions, at which the inner wall surfaces meet the continuous non-spherical curved portion, to an uppermost position which is a central portion of the continuous non-spherical curved portion so as to reflect the light of the light input portion to the first Bezier curved surfaces, the second Bezier curved surfaces, and the third Bezier curved surfaces.

In a front view of the light input portion, the continuous non-spherical curved portion may include a curved central portion provided in a circular shape and positioned between a pair of the first Bezier curved surfaces vertically disposed to be spaced apart from each other; and curved wing portions each of which continuously extends to have a curved surface from both sides of the curved central portion to the corner portions without a vertical step.

Each of the reflector and the light output portion may be formed in one shape among a square shape, a rectangular shape, a quadrangular shape having a round corner, and a polygonal shape so that the light is refracted by the curved central portion of the continuous non-spherical curved portion or the curved wing portions of the light input portion, the refracted light is totally internally reflected by the first Bezier curved surface, the second Bezier curved surface, and the third Bezier curved surface of the reflector, and the light forms a variety of patterns.

In the reflector, a focal length due to the continuous non-spherical curved portion may be smaller than that of a lens manufactured by combining total internal reflection structures having different shapes and having a vertical step, and a length of one Bezier curved surface among the first Bezier curved surface, the second Bezier curved surface, and the third Bezier curved surface may be smaller than that of the lens having the vertical step.

The reflector may further include a coupling protrusion formed on a top or bottom surface of the reflector for installing a lens.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a multi-facet lens (MFL) according to a conventional technology;

FIG. 2 is a rear view illustrating the MFL illustrated in FIG. 1;

FIG. 3 is an enlarged perspective view of a dotted line area II illustrated in FIG. 2;

FIG. 4 is a perspective view illustrating an MFL having a continuous non-spherical curved portion according to one embodiment of the present invention;

FIG. 5 is a front view illustrating a light input portion of the MFL having a continuous non-spherical curved portion illustrated in FIG. 4;

FIG. 6 is an enlarged perspective view of a dotted line area V illustrated in FIG. 5; and

FIG. 7 is a cross-sectional view taken along line A-A of FIG. 5.

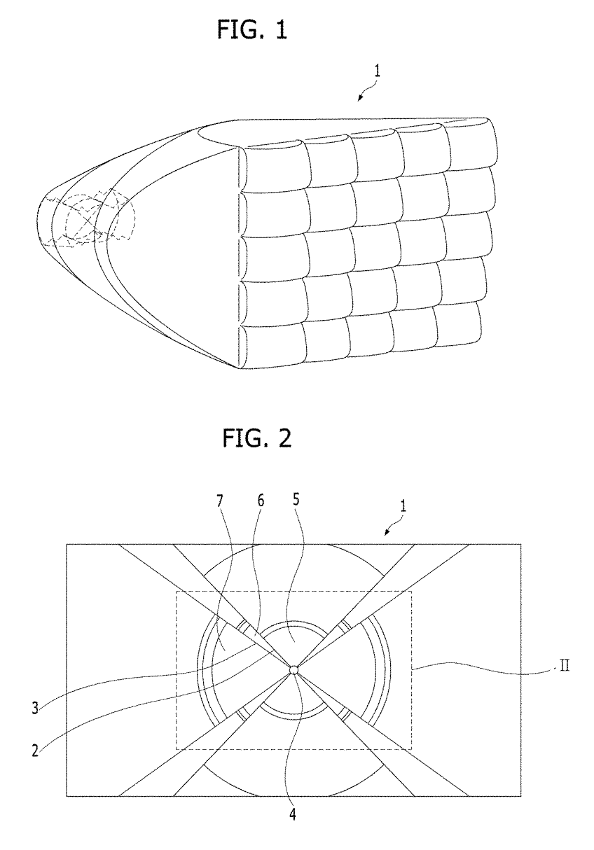

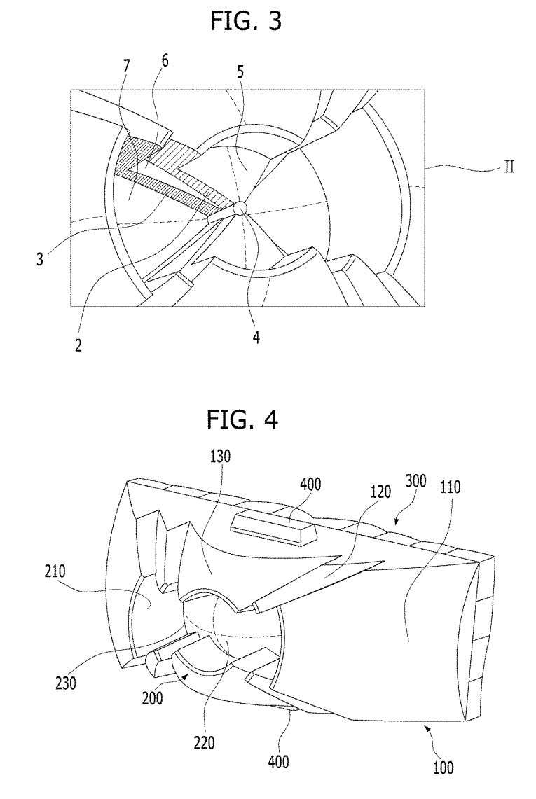

### DETAILED DESCRIPTION OF EXEMPLARY EMBODIMENTS

Advantages and features of the present invention and methods of achieving the same will be clearly understood with reference to the accompanying drawings and the following detailed embodiments. However, the present invention is not limited to the embodiments to be disclosed, but may be implemented in various different forms. The embodiments are provided in order to fully explain the present invention and fully explain the scope of the present invention for those skilled in the art. The scope of the present invention is defined by the appended claims.

Meanwhile, the terms used herein are provided to only describe embodiments of the present invention and not for purposes of limitation. Unless the context clearly indicates otherwise, the singular forms include the plural forms. It will be understood that the terms “comprise” or “comprising” when used herein, specify some stated components, steps, operations and/or elements, but do not preclude the presence or addition of one or more other components, steps, operations and/or elements. Hereinafter, embodiments of the present invention will be described with reference to accompanying drawings in detail.

In addition, a light input portion of a lens may be a front surface of the lens and a light output portion of the lens may be a rear surface of the lens so as to clearly describe main portions of the present invention in the following description.

FIG. 4 is a perspective view illustrating a multi-facet lens (MFL) having a continuous non-spherical curved portion according to one embodiment of the present invention.

Referring to FIG. 4, the present embodiment discloses the MFL having a continuous non-spherical curved portion. The MFL having a continuous non-spherical curved portion includes a reflector 100, a light input portion 200, and a light output portion 300.

The reflector 100, the light input portion 200, and the light output portion 300 may be defined through designing a structure having a plurality of total internal reflection (TIR) lenses. Here, a shape and the structure of the light input portion 200 may vary for each lens product. Detailed shapes or dimensions of the reflector 100, the light input portion 200, and the light output portion 300 may vary.

The reflector 100, the light input portion 200, and the light output portion 300 may be manufactured by injection molding. The reflector 100, the light input portion 200, and the light output portion 300 may be formed of one material among a plastic material, an optical glass material, a raw material of lens for plastic lens manufacturing. Here, the raw material of the lens may be selected from the above materials by considering optical properties, such as reflectivity transparency, etc., processability of the raw material, and the like.

For example, the raw material of the lens may be one of an optical plastic including Zeonex E48R which is a cyclo-olefin polymer (COP), Planet SP1516 which is a polycarbonate (PC) resin, and APEL optical plastic which is a COP. In addition, the raw material of the lens may be one material selected from the group consisting of an optical thermoplastic material, a silicone, or a synthetic resin material that are known in the related industry. When a material or a raw material has a suitable property for manufacturing the MFL having a continuous non-spherical curved portion which will be described in the present embodiment, since one among a plastic material, a synthetic resin material, a polymeric compound, an optical resin, and an optical glass material may be used for the present embodiment, the raw material of the lens may not be limited to a specific material.

The present embodiment includes a continuous non-spherical curved portion without a dummy surface or a vertical step. The continuous non-spherical curved portion is formed in the light input portion 200.

In the present embodiment, a scattered reflection of a conventional MFL may be prevented. In the present embodiment, luminous efficiency may relatively be improved. In the present embodiment, a total lens thickness may relatively be decreased. In the present embodiment, processability and a property of injection molding are improved when manufacturing, and a cost reduction is achieved. In addition, in the present embodiment, the improved lens processability and the property of injection molding may be achieved by removing a conventional vertical step.

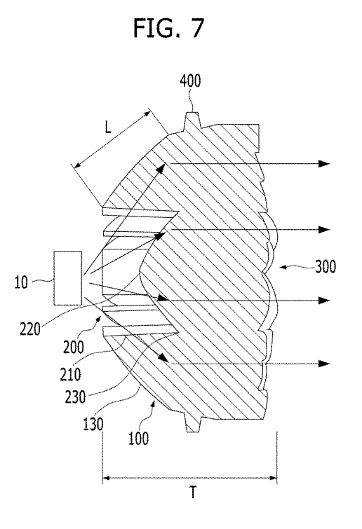

For example, the reflector 100 may be a TIR structure such that light emitted from a light source (see FIG. 7) is collected while having a feature of straightness parallel to an optical axis. The TIR structure which is the reflector 100 includes first Bezier curved surfaces 110, second Bezier curved surfaces 120, and third Bezier curved surfaces 130, which have shapes different form each other.

The first Bezier curved surfaces 110, the second Bezier curved surfaces 120, and the third Bezier curved surfaces 130 are formed at an outside of the reflector 100. The first Bezier curved surfaces 110, the second Bezier curved surfaces 120, and the third Bezier curved surfaces 130 may be reflective surfaces of light.

In addition, the numbers of the first Bezier curved surfaces 110, the second Bezier curved surfaces 120, and the third Bezier curved surfaces 130 may vary according to a lens specification such as a shape, a structure, or a reflectivity of the lens, and thus the numbers thereof may not be limited to a specific number.

Here, an overall shape of the reflector 100 is a rectangular or polygonal shape, and the reflector 100 has a longitudinal length smaller than a lateral length.

Because of such a shape of the reflector 100, the first Bezier curved surfaces 110 may protrude more than the second Bezier curved surfaces 120 with respect to an area close to the light input portion 200. In addition, the second Bezier curved surfaces 120 may protrude more than the third Bezier curved surfaces 130 with respect to an area close to the light input portion 200.

The light output portion 300 is integrally formed at one side of the reflector 100 and serves to emit light incident through the light input portion 200 and light totally internally reflected in the reflector 100 to be parallel to the optical axis.

For example, the light output portion 300 may include a plurality of lens segments configured to guide light toward the optical axis. Here, the lens segments are formed with a plurality of convex or concave lenses.

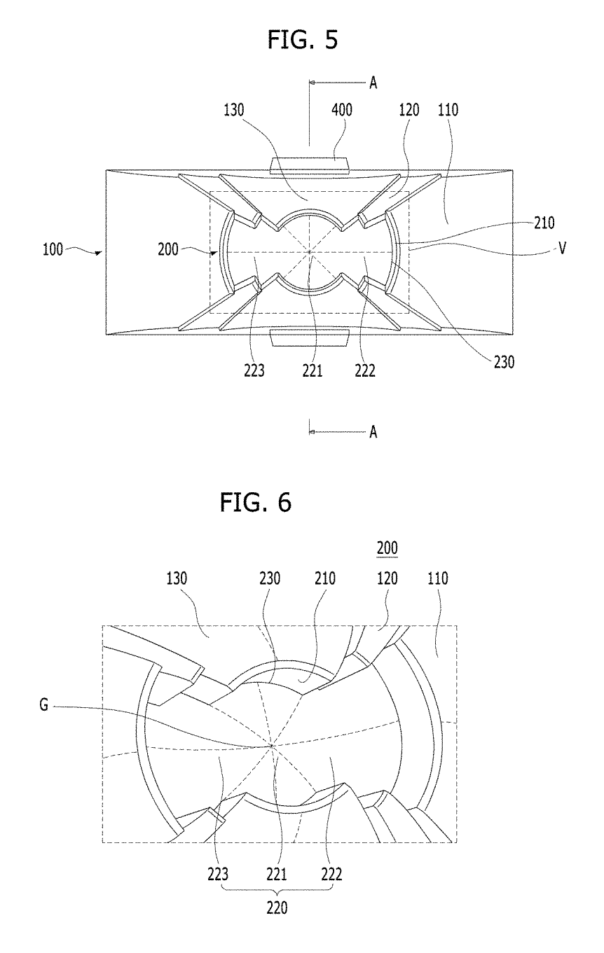

FIG. 5 is a front view illustrating a light input portion of the MFL having a continuous non-spherical curved portion illustrated in FIG. 4, FIG. 6 is an enlarged perspective view of a dotted line area V illustrated in FIG. 5, and FIG. 7 is a cross-sectional view taken along line A-A of FIG. 5.

Referring to FIGS. 5 to 7, the light input portion 200 includes inner wall surfaces 210 and a continuous non-spherical curved portion 220.

The inner wall surfaces 210 are integrally formed at the other side of the reflector 100. The inner wall surfaces 210 extend from edges of the first Bezier curved surfaces 110, the second Bezier curved surfaces 120, and the third Bezier curved surfaces 130 in an inward direction of the reflector 100.

The continuous non-spherical curved portion 220 may correspond to a bottom surface of a groove-shaped space surrounded by the inner wall surfaces 210.

The vertical step and the dummy surface described through a conventional technology do not exist at a center G of the continuous non-spherical curved portion 220. The continuous non-spherical curved portion 220 may be manufactured by non-step designing.

The continuous non-spherical curved portion 220 may be formed with a curved surface which extends from corner portions 230, at which the inner wall surfaces 210 meet the continuous non-spherical curved portion 220, to an uppermost position which is the center G of the continuous non-spherical curved portion 220. Light of the light input portion 200 may be reflected to the first Bezier curved surfaces 110, the second Bezier curved surfaces 120, and the third Bezier curved surfaces 130 by the continuous non-spherical curved portion 220. Here, the curved surface may refer to a surface of the continuous non-spherical curved portion 220 without a conventional vertical step or dummy surface.

For example, the continuous non-spherical curved portion 220 may be formed with a curved central portion 221 and curved wing portions 222 and 223 in a front view of the light input portion 200.

The curved central portion 221 and the curved wing portions 222 and 223 may have a shape in which twin arrows are connected at both sides of a central circle thereof. That is, the corner portions 230 may be formed in a shape of a curved or zigzag line in a front view thereof.

The curved central portion 221 may be positioned between a pair of first Bezier curved surfaces 110 vertically disposed to be spaced apart from each other and may be formed in a circular shape in a plan view.

Referring to FIG. 7, the curved central portion 221 has a stereoscopic shape. For example, the curved central portion 221 may have one shape among a protruding shape, a convex shape, and a bell shape curved from the light output portion 300 in a direction of the light input portion 200 in a cross-sectional view thereof.

The curved wing portions 222 and 223 continuously extend in a shape of a curved surface from both sides of the curved central portion 221 to the corner portions 230 without a vertical step.

Because a detailed shape, a curvature, or the like of a surface of the continuous non-spherical curved portion 220 may be different for each lens product, the detailed shape, the curvature, or the like thereof may not be limited to a specific value.

In addition, referring again to FIG. 4 or 5, the reflector 100 and the light output portion 300 may refract light through the curved central portion 221 or the curved wing portions 222 and 223 of the continuous non-spherical curved portion 220 of the light input portion 200, and may totally internally reflect the refracted light through the first Bezier curved surfaces 110, the second Bezier curved surfaces 120, and the third Bezier curved surfaces 130 of the reflector 100. To this end, the reflector 100 and the light output portion 300 may be formed in one shape among a square shape, a rectangular shape, a quadrangular shape having a round corner, and a polygonal shape for a variety of patterns of light.

Referring to FIG. 7, when a conventional lens which is manufactured by bonding or combining total internal reflection structures having shapes different from each other and has vertical steps is compared with the reflector 100 of the present invention, a focal length of the continuous non-spherical curved portion 220 may be shortened at the reflector 100. In addition, a length L of one among the first Bezier curved surfaces 110, the second Bezier curved surfaces 120, and the third Bezier curved surfaces 130 may be smaller than that of the conventional lens having the vertical steps.

Accordingly, because a thickness T of a lens between the light input portion 200 and the light output portion 300 may also relatively be small and thus the total volume of the MFL having a continuous non-spherical curved portion is relatively decreased, an amount of the raw material of the lens and a manufacturing cost can be decreased.

That is, a focal point of the continuous non-spherical curved portion 220 is shifted toward the light output portion 300 compared to the conventional lens having the vertical steps, and thus the focal length related to the continuous non-spherical curved portion 220 is shortened. The length L of each of the Bezier curved surfaces 110, 120, and 130 is also shortened due to the continuous non-spherical curved portion 220, and a volume of the lens is decreased according to a decrease in the lens thickness T. As a result, because the present embodiment provides a light and slim optical device as a component for a lighting device of a vehicle, a performance of mounting the optical device on the vehicle may be maximized.

In addition, according to the present embodiment, the reflector 100 includes coupling protrusions 400 for installing a lens, which is integrally formed at a top or bottom surface thereof. An installation performance, such as a lens fixing or lens assembly, may be maximized by the coupling protrusion 400 of the reflector 100.

Accordingly, in the present embodiment, because the continuous non-spherical curved portion 220 is provided and the continuous non-spherical curved portion 220 does not include the vertical steps inevitably formed when TIR lens structures different from each other are combined, the Bezier curved surfaces 110, 120, and 130 may be optimized.

That is, in the present embodiment, an allowance rate of the length of the outermost Bezier curved surface 110 may be obtained due to the continuous non-spherical curved portion 220 having the focal length shortened by non-step designing.

In addition, because a non-step is implemented in the present embodiment, a central dummy surface does not exist, and thus luminous efficiency is improved.

In addition, in the present embodiment, scattered reflection due to each of the vertical steps does not occur, and the luminous efficiency can be improved by 10% or more than that of the same conventional light source.

That is, an optical performance of the MFL having a continuous non-spherical curved portion according to the present embodiment can improve a performance of a lighting device or driving beam headlamp by 10% or more. In terms of improvement of energy performance, power consumption and consumption efficiency of the light source 10, such as an LED, can be improved by 10% according to the present embodiment.

In addition, because there is no vertical step according to the present embodiment, mold manufacturing and injection molding can be more easily performed, a lens manufacturing process may become convenient, and cost can be decreased for mass production.

In addition, in terms of cost reduction according to the present embodiment, cost can be decreased due to a decrease in a weight of a heat sink which is a heat dissipation device because a brightness of an LED light source can be decreased, and there is also an effect of cost reduction because the number of the LED devices is relatively decreased.

In addition, in terms of eco-friendliness according to the present embodiment, there is an effect of providing a driver-centric technology for improving a safe and convenient driving of a driver.

As described above, the MFL having a continuous non-spherical curved portion according to the present invention is advantageous for improving luminous efficiency by achieving TIR on an entire area of the lens caused by removing a dummy surface.

Because the MFL having a continuous non-spherical curved portion according to the present invention includes a continuous non-spherical curved portion in a light input portion instead of vertical steps included in the conventional case, scattered reflections due to the vertical steps may be prevented. Accordingly, even when the same light sources are respectively used for the MFLs included in the present invention and the conventional technology, the luminous efficiency of the MFL according to the present invention is improved by 10% or more than that of the MFL of the conventional technology. The improvement of the luminous efficiency can be an advantage of the present invention in which an amount of power or energy consumption can be decreased.

The MFL having a continuous non-spherical curved portion according to the present invention has a focal length shortened due to a continuous non-spherical curved portion and a total lens thickness decreased due to the continuous non-spherical curved portion. Accordingly, an amount of raw material necessary for manufacturing the lens is decreased and a manufacturing cost is reduced.

Because the MFL having a continuous non-spherical curved portion according to the present invention has a continuous non-spherical curved portion in which vertical steps are removed, processability and an injection performance of a lens can be improved.

While the present invention has been particularly described with reference to exemplary embodiments, it will be understood by those of skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims.

### REFERENCE NUMERALS

10: LIGHT SOURCE
100: REFLECTOR
110: FIRST BEZIER CURVED SURFACE
120: SECOND BEZIER CURVED SURFACE
130: THIRD BEZIER CURVED SURFACE
200: LIGHT INPUT PORTION
210: INNER WALL SURFACE
220: CONTINUOUS NON-SPHERICAL CURVED PORTION
230: CORNER PORTION
300: LIGHT OUTPUT PORTION

What is claimed is:

1. A multi-facet lens having a continuous non-spherical curved portion, comprising:
a reflector provided with a total internal reflection structure including a first Bezier curved surface, a second Bezier curved surface, and a third Bezier curved surface, which have different shapes, such that light emitted from a light source is collected while having a feature of straightness parallel to an optical axis;
a light input portion integrally formed at one side of the reflector and including inner wall surfaces extending from edges of the first Bezier curved surface, the second Bezier curved surface, and the third Bezier curved surface in an inward direction of the reflector, and a continuous non-spherical curved portion corresponding to a bottom surface of a groove-shaped space surrounded by the inner wall surfaces; and
a light output portion integrally formed at the other side of the reflector and configured to emit light incident through the light input portion and light totally internally reflected by the reflector to be parallel to the optical axis.

2. The multi-facet lens of claim 1, wherein the continuous non-spherical curved portion is formed in a curved surface extending from corner portions, at which the inner wall surfaces meet the continuous non-spherical curved portion, to an uppermost position which is a central portion of the continuous non-spherical curved portion so as to reflect the light of the light input portion to the first Bezier curved surface, the second Bezier curved surface, and the third Bezier curved surface.

3. The multi-facet lens of claim 2, wherein, in a front view of the light input portion, the continuous non-spherical curved portion includes:
a curved central portion provided in a circular shape and positioned between a pair of the first Bezier curved surfaces vertically disposed to be spaced apart from each other; and
curved wing portions each of which continuously extends to have a curved surface from both sides of the curved central portion to the corner portions without a vertical step.

4. The multi-facet lens of claim 3, wherein each of the reflector and the light output portion is formed in one shape among a square shape, a rectangular shape, a quadrangular shape having a round corner, and a polygonal shape so that the light is refracted by the curved central portion of the continuous non-spherical curved portion or the curved wing portions of the light input portion, the refracted light is totally internally reflected by the first Bezier curved surface, the second Bezier curved surface, and the third Bezier curved surface of the reflector, and the light forms a variety of patterns.

5. The multi-facet lens of claim 2, wherein, in the reflector, a focal length due to the continuous non-spherical curved portion is smaller than that of a lens manufactured by combining total internal reflection structures having different shapes and having a vertical step, and a length of one Bezier curved surface among the first Bezier curved surface, the second Bezier curved surface, and the third Bezier curved surface is smaller than that of the lens having the vertical step.

6. The multi-facet lens of claim 2, wherein the reflector includes a coupling protrusion formed on a top or bottom surface of the reflector for installing a lens.
